(19) United States
(12) Patent Application Publication
(10) Pub. No.: US 2025/0000177 A1
(43) Pub. Date: Jan. 2, 2025

(54) Enhanced Vaping Device

(71) Applicants: Jontaya Hill, Queen Creek, AZ (US); Owo Mobio, Queen Creek, AZ (US)

(72) Inventors: Jontaya Hill, Queen Creek, AZ (US); Owo Mobio, Queen Creek, AZ (US)

(21) Appl. No.: 18/751,441

(22) Filed: Jun. 24, 2024

Related U.S. Application Data
(60) Provisional application No. 63/510,459, filed on Jun. 27, 2023.

(51) Int. Cl. A24F 40/65; A24F 40/40; H04W 4/029

(52) U.S. Cl. CPC A24F 40/65; A24F 40/40; H04W 4/029

(57) ABSTRACT

A vaping device is disclosed that integrates GPS technology to locate the device using Bluetooth and a mobile app. The vaping device comprises a battery component, wherein the top has a screw-on vape, atomizer/tank and a magnetic vape pod insert that is internally flat on the surface. The bottom of the battery component has a speaker for an audible chime/alert and a microphone for voice recognition/command. The device pairs with a phone via Bluetooth and uses a mobile app to show the location of the device. The audible alert can also be used to locate the device. There are indicator lights to show that the device is paired to Bluetooth correctly and that the magnetic pods are correctly in place.

### CROSS-REFERENCE TO RELATED APPLICATION

The present application claims priority to, and the benefit of, U.S. Provisional Application No. 63/510,459, which was filed on Jun. 27, 2023, and is incorporated herein by reference in its entirety.

### FIELD OF THE INVENTION

The present invention relates generally to the field of vaping devices. More specifically, the present invention relates to a vaping device with integrated GPS technology to enable users to track its location. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in vaping devices. Generally, a large number of individuals use a vaping device and are always at risk of misplacing it or leaving it behind. Currently, there is not a simple and effective method for locating a missing vape pen/device. After fruitless hours of searching, users may end up having to replace their device, which can be costly and inconvenient.

While they are certainly useful to various people, electronic cigarettes may sometimes bring about some additional considerations. For example, in some cases, it may undesirable for certain persons to readily use electronic cigarettes, or someone who may have stolen or found an electronic cigarette belonging to somebody else may attempt to use it.

Accordingly, there is a demand for a vaping device that is integrated with GPS technology to enable users to track its location. More particularly, there is a demand for a vaping device which connects to a phone using Bluetooth technology and offers a mobile app to assist users in pinpointing the location of the device.

Therefore, there exists a long felt need in the art for a vaping device that provides users with a device with integrated GPS technology to enable users to track its location. There is also a long felt need in the art for a vaping device that connects to a phone using Bluetooth technology and offers a mobile app to assist users in pinpointing the location of the device. Further, there is a long felt need in the art for a vaping device that sounds an alert to help individuals find their vaping device within close proximity. Moreover, there is a long felt need in the art for a device that features a modern style handheld vaping device with magnetic or screw-in pods. Further, there is a long felt need in the art for a vaping device that features a vape atomizer that can contain tobacco, nicotine, non-nicotine, cannabis, CBD, and essential oils. Finally, there is a long felt need in the art for a vaping device that includes an option for voice activation, on-the-go charging, and a flashlight.

The subject matter disclosed and claimed herein, in one embodiment thereof, comprises a vaping device. The device contains integrated GPS technology that enables the device to be located using Bluetooth and a mobile app. The vaping device comprises a battery component, wherein the top has a screw-on vape, atomizer/tank and a magnetic vape pod insert that is internally flat on the surface. The bottom of the battery component has a speaker for an audible chime/alert and a microphone for voice recognition/command. The device pairs with a phone via Bluetooth and uses a mobile app to show the location of the device. The audible alert can also be used to locate the device. There are indicator lights to show that the device is paired to Bluetooth correctly and that the magnetic pods are correctly in place. On the left side there is a wrist lanyard. There may be an optional flashlight and charging port to charge other devices. The battery is meant to last approximately 48 hours. Further, the mobile app may have additional data within, such as usage analysis, etc.

In this manner, the vaping device of the present invention accomplishes all of the forgoing objectives and provides users with a device that connects to a phone and utilizes a mobile app for locating the device, as needed. The device sounds an alert when located or communicates via the mobile app.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vaping device. The device contains integrated GPS technology that enables the device to be located using Bluetooth and a mobile app. The vaping device comprises a battery component with multiple functionality. The device pairs with a smartphone via Bluetooth and uses a mobile app to show the location of the device. The battery is meant to last approximately 48 hours. Further, the mobile app may have additional data within, such as usage analysis, etc.

In one embodiment, the vaping device has integrated GPS technology to enable users to track the location of a vape. The device connects to a phone using Bluetooth technology and offers a mobile app to assist users in pinpointing the location of the vape. Further, the mobile app will have a push notification to notify a user if the device is left somewhere.

In one embodiment, the vaping device comprises a battery component. The battery component is typically a lithium battery, but can be any suitable battery as is known in the art. The battery component comprises a top surface, a bottom surface, a top side, an opposing bottom side, and opposing sidewalls. The battery component is typically in a rectangular shape but can be any suitable shape as is known in the art. The battery component provides approximately 48 hours of charge and is rechargeable, as needed. The battery component provides on-the-go charging for vapes and other devices.

In one embodiment, the top side of the battery component comprises two ports, a first port for screwing on a vape atomizer/tank and a second port for inserting a magnetic vape pod. a mouthpiece is releasably secured to a front end of the vape atomizer. The body of the vape atomizer contains a liquid, such as tobacco, nicotine, non-nicotine, cannabis, CBD, and essential oils, or any combination thereof. The magnetic vape pod is internally flat on the surface and typically houses the rechargeable battery. Generally, the vape atomizer and magnetic vape pod are attached together during use. Electricity is supplied from the battery to the atomizer. An intelligent single chip (i.e., integrated circuit (IC)) of the vape atomizer is thus activated to power a heating element for vaporizing the liquid. And in turn, the liquid is turned into a vapor which is then inhaled by the user (i.e., simulating tobacco smoking). Any suitable vape atomizer and/or magnetic vape pod can be utilized as is known in the art, depending on the wants and/or needs of a user. Further, the vape atomizer and/or magnetic vape pod are reusable, such that either or both may be replenished with an additional amount of the substance to keep producing vapor. Furthermore, the enclosed battery is also rechargeable and reusable.

In one embodiment, the bottom side of the battery component comprises a speaker for an audible chime/alert and a microphone for voice recognition and/or voice commands. Thus, a user can audibly speak voice commands, such as ‘find my vape’ and then be alerted via an audible alert/chime when the vape has been located. The microphone can also comprise voice recognition, preventing others from picking up the battery component and locating the vape.

In one embodiment, the bottom side can also comprise a charging port for charging other devices, as needed. These devices can include, vapes, cellular phones, smartwatches, iPads, iPods, etc., or any other suitable device as is known in the art. Further, any suitable charging port can be utilized as well.

In one embodiment, the battery component comprises indicator lights to show that the device is paired to Bluetooth correctly and that the magnetic pods and vape atomizer are correctly in place. The indicator lights can also show if the battery component needs to be recharged and to show if the device is powered on or off. Any suitable number of indicator lights can be utilized as is known in the art.

In one embodiment, the battery component also comprises a flashlight. The flashlight is optional but can be included on any suitable position on the battery component, depending on the needs and/or wants of a user.

In one embodiment, the battery component comprises a wrist lanyard or other suitable means for releasably securing the device to a user. The wrist lanyard secures around a user's wrist and allows the device to be easily transported, as needed.

In one embodiment, the battery component connects to a smart phone using Bluetooth technology and pairs with a mobile app to assist users in pinpointing the location of the device. Accordingly, the battery component includes a wireless communications module and additional sensors which would allow the device to pair with a mobile application on a smart device. Once paired, a user could control and locate the vaping device via the mobile application.

In one embodiment, the battery component comprises a controller which includes a software and hardware assembly and Bluetooth technology. The software and hardware assembly and the Bluetooth technology are disposed separately so that a replacement of any of them can be made easy. Alternatively, they can be disposed as a unit. Further, the controller comprises suitable circuitry and/or software for sending signals to and receiving signals from other components of the vaping device to which it is connected, including, in this embodiment, a user interface, a power source, and a vape, in order to control operation of the vaping device.

In one embodiment, the battery component comprises a microcontroller unit (MCU) for controlling the vape atomizer and providing data about usage analysis to the software and hardware assembly. The Bluetooth technology can transmit data processed by the MCU and can receive data from an external device and transmit same to the MCU. The battery component is electrically connected to the MCU so that electricity can be supplied from the battery component to the MCU for its normal operation.

In one embodiment, the Bluetooth technology is wirelessly connected to a mobile app. The mobile app may also have additional data within, which can be utilized to provide usage analysis and other suitable data measurements, as is known in the art. Thus, data processed by the MCU can be transmitted to the mobile app via Bluetooth technology. Further, the mobile app can transmit data to the MCU via Bluetooth technology, as well. Thus, the mobile app can keep track of date and time of vape use and other usage analysis, as is known in the art.

In yet another embodiment, the vaping device comprises a plurality of indicia.

In yet another embodiment, a method of locating a vape via integrated GPS technology is disclosed. The method includes the steps of providing a vaping device comprising a battery component with additional functionality. The method also comprises inserting the vape atomizer and magnetic vape pod into the ports of the battery component. Further, the method comprises pairing the device with a mobile app to locate the device, as needed. The method also comprises utilizing indicator lights and audible alerts from the battery component. Finally, the method comprises utilizing on-the-go charging and the flashlight of the battery component, as needed.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the vaping device of the present invention showing the battery component of the device in accordance with the disclosed architecture;

FIG. 2 illustrates a perspective view of one embodiment of the vaping device of the present invention showing the connection ports of the device in accordance with the disclosed architecture;

FIG. 3 illustrates a perspective view of one embodiment of the vaping device of the present invention showing the vape atomizer being inserted in accordance with the disclosed architecture;

FIG. 4 illustrates a perspective view of one embodiment of the vaping device of the present invention showing the magnetic vape pod being inserted in accordance with the disclosed architecture;

FIG. 5 illustrates a perspective view of one embodiment of the vaping device of the present invention showing the speaker, microphone, and charging port of the device in accordance with the disclosed architecture; and

FIG. 6 illustrates a flowchart showing the method of locating a vape via integrated GPS technology in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a vaping device that provides users with a device with integrated GPS technology to enable users to track its location. There is also a long felt need in the art for a vaping device that connects to a phone using Bluetooth technology and offers a mobile app to assist users in pinpointing the location of the device. Further, there is a long felt need in the art for a vaping device that sounds an alert to help individuals find their vaping device within close proximity. Moreover, there is a long felt need in the art for a device that features a modern style handheld vaping device with magnetic or screw-in pods. Further, there is a long felt need in the art for a vaping device that features a vape atomizer that can contain tobacco, nicotine, non-nicotine, cannabis, CBD, and essential oils. Finally, there is a long felt need in the art for a vaping device that includes an option for voice activation, on-the-go charging, and a flashlight.

The present invention, in one exemplary embodiment, is a novel vaping device. The device contains integrated GPS technology that enables the device to be located using Bluetooth and a mobile app. The vaping device comprises a battery component, wherein the top has a screw-on vape, atomizer/tank and a magnetic vape pod insert that is internally flat on the surface. The bottom of the battery component has a speaker for an audible chime/alert and a microphone for voice recognition/command. The device pairs with a phone via Bluetooth and uses a mobile app to show the location of the device. The audible alert can also be used to locate the device. There are indicator lights to show that the device is paired to Bluetooth correctly and that the magnetic pods are correctly in place. The present invention also includes a novel method of locating a vape via integrated GPS technology. The method includes the steps of providing a vaping device comprising a battery component with additional functionality. The method also comprises inserting the vape atomizer and magnetic vape pod into the ports of the battery component. Further, the method comprises pairing the device with a mobile app to locate the device, as needed. The method also comprises utilizing indicator lights and audible alerts from the battery component. Finally, the method comprises utilizing on-the-go charging and the flashlight of the battery component, as needed.

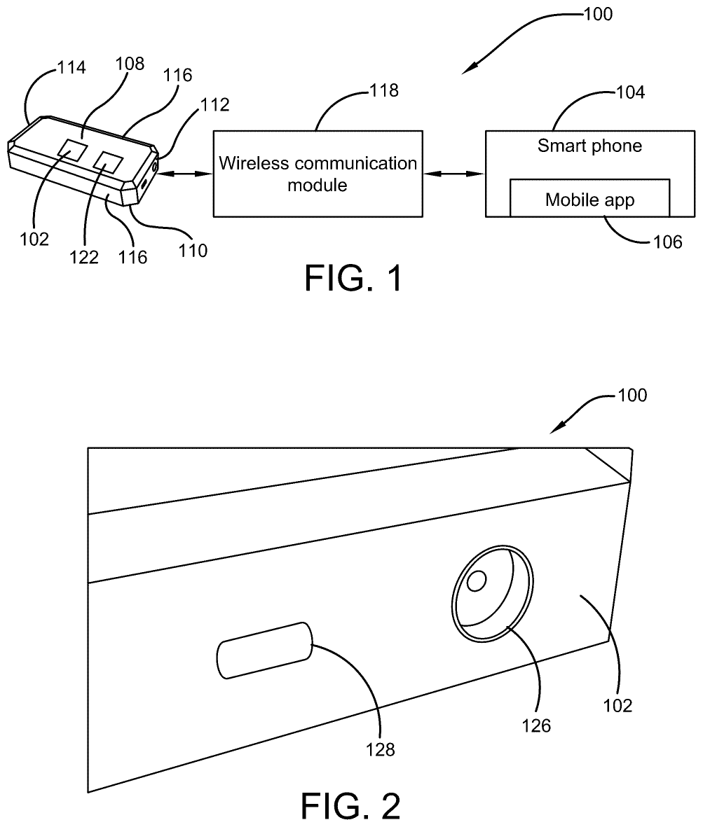

Referring initially to the drawings, FIG. 1 illustrates a perspective view of one embodiment of the vaping device 100 of the present invention. In the present embodiment, the vaping device 100 is an improved vaping device 100 that includes integrated GPS technology to enable location of a vape. Specifically, the vaping device 100 comprises a battery component 102 with additional functionality. The device 100 pairs with a smartphone 104 via Bluetooth technology and uses a mobile app 106 to show the location of the device 100. The battery component 102 is meant to last approximately 48 hours. Further, the mobile app 106 may have additional data within, such as usage analysis, etc.

Further, the battery component 102 is typically a lithium battery, but can be any suitable battery as is known in the art. The battery component 102 comprises a top surface 108, a bottom surface 110, a top side 112, an opposing bottom side 114, and opposing sidewalls 116. The battery component 102 is typically in a rectangular shape but can be any suitable shape as is known in the art. The battery component 102 provides approximately 48 hours of charge and is rechargeable, as needed. The battery component 102 provides on-the-go charging for vapes and other devices.

Accordingly, the battery component 102 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the vaping device 100. Throughout this specification, the term “battery” may be used interchangeably to refer to one or more wet or dry cells or batteries of cells in which chemical energy is converted into electricity and used as a source of DC power. References to recharging or replacing the battery 102 may refer to recharging or replacing individual cells, individual batteries of cells, or a package of multiple battery cells as is appropriate for any given battery technology that may be used. In addition, a rechargeable embodiment of the battery 102 may be recharged using a USB port (not shown), wherein the USB port is a USB-A, USB-B, Micro-B, Micro-USB, Mini-USB, or USB-C port, etc.

Furthermore, the battery component 102 connects to a smartphone 104 using Bluetooth technology and pairs with a mobile app 106 to assist users in pinpointing the location of the device 100. Accordingly, the battery component 102 includes a wireless communications module 118 and additional sensors which would allow the device 100 to pair with a mobile application 106 on a smart device 104. Once paired, a user could control and locate the vaping device 100 via the mobile application 106.

Typically, the mobile device or smart device 104 may be a cellular telephone, a remote control, or any other device that may have wireless communication capabilities and may be connected to the internet. The mobile or smart device 104 may perform any type of wireless communication, including, but not limited to, WIFI, BLUETOOTH, RFID, NFC, etc. The device 100 further includes a wireless communication module 118 and additional sensors which would allow the device 100 to pair with a mobile application 106 on a mobile or smart device 104. Once paired, a user could control the vaping device 100 via the mobile application 106.

Generally, the vaping device 100 may interact with the smartphone 104 over a communication link, which may be wireless, wired, or partly wireless and partly wired (i.e., Bluetooth or other short-range or near-field wireless connection, WiFi or other wireless LAN, WiMAX or other wireless WAN, cellular, Universal Serial Bus (USB), etc.). In some cases, such as where the smartphone 104 is a tablet, head-mounted display, smartwatch, or other communication device carried or worn by the user of the device 100, the communication between the vaping device 100 and the smartphone 104 may be direct, i.e., without any intermediate device. For instance, in some embodiments, this can be achieved by pairing (i.e., Bluetooth pairing) the smartphone 104 with the vaping device 100.

In other cases, such as where the smartphone 104 communicates with a server remote from the vaping device 100, communication between the smartphone 104 and the vaping device 100 may be indirect, i.e., through one or more networks and/or one or more additional smartphones. For example, in some embodiments, the vaping device 100 may communicate with a WiFi hotspot or cellular base station, which may provide access to a service provider and ultimately the Internet or another network, thereby allowing the vaping device 100 and the smartphone 104 to communicate (i.e., exchange information). As another example, in some embodiments, communication between the smartphone 104 and the vaping device 100 may take place through a smartphone 104, tablet, head-mounted display, smartwatch, or other communication device which is carried or worn by the user and which itself may have established communication with a WiFi hotspot or cellular base station.

Furthermore, the battery component 102 comprises a controller 120 which includes a software and hardware assembly and Bluetooth technology. The software and hardware assembly and the Bluetooth technology are disposed separately so that a replacement of any of them can be made easy. Alternatively, they can be disposed as a unit. Further, the controller 120 comprises suitable circuitry and/or software for sending signals to and receiving signals from other components of the vaping device 100 to which it is connected, including, in this embodiment, a user interface, a power source, and a mobile app 106, in order to control operation of the vaping device 100.

Additionally, the battery component 102 comprises a microcontroller unit (MCU) 122 for controlling a vape atomizer 124 and providing data about usage analysis to the software and hardware assembly. The Bluetooth technology can transmit data processed by the MCU 122 and can receive data from an external device and transmit same to the MCU 122. The battery component 102 is electrically connected to the MCU 122 so that electricity can be supplied from the battery component 102 to the MCU 122 for its normal operation.

Further, the Bluetooth technology is wirelessly connected to a mobile app 106. The mobile app 106 may also have additional data within, which can be utilized to provide usage analysis and other suitable data measurements, as is known in the art. Thus, data processed by the MCU 122 can be transmitted to the mobile app 106 via Bluetooth technology. Further, the mobile app 106 can transmit data to the MCU 122 via Bluetooth technology, as well. Thus, the mobile app 106 can keep track of date and time of vape use and other usage analysis, as is known in the art.

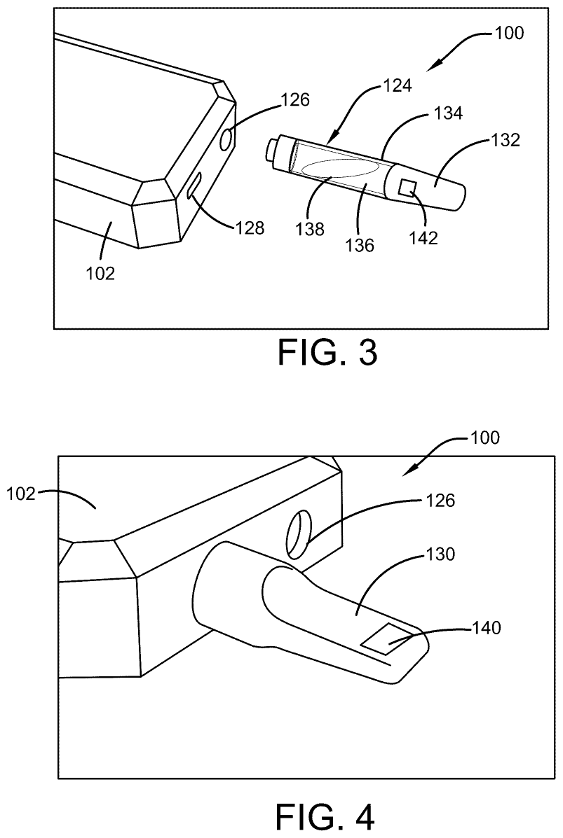

As shown in FIGS. 2-4, the top side 108 of the battery component 102 comprises two ports, a first port 126 for screwing on a vape atomizer/tank 124 and a second port 128 for inserting a magnetic vape pod 130. A mouthpiece 132 is releasably secured to a front end 134 of the vape atomizer 124. The body 136 of the vape atomizer 124 contains a liquid 138, such as tobacco, nicotine, non-nicotine, cannabis, CBD, and essential oils, or any combination thereof. The magnetic vape pod 130 is internally flat on the surface and typically houses the rechargeable battery 140. Generally, the vape atomizer 124 and magnetic vape pod 130 are attached together during use. Electricity is supplied from the battery 140 to the atomizer 124. An intelligent single chip 142 (i.e., integrated circuit (IC)) of the vape atomizer 124 is thus activated to power a heating element for vaporizing the liquid 138. And in turn, the liquid 138 is turned into a vapor which is then inhaled by the user (i.e., simulating tobacco smoking). Any suitable vape atomizer 124 and/or magnetic vape pod 130 can be utilized as is known in the art, depending on the wants and/or needs of a user. Further, the vape atomizer 124 and/or magnetic vape pod 130 are reusable, such that either or both may be replenished with an additional amount of the substance to keep producing vapor. Furthermore, the enclosed battery 140 is also rechargeable and reusable.

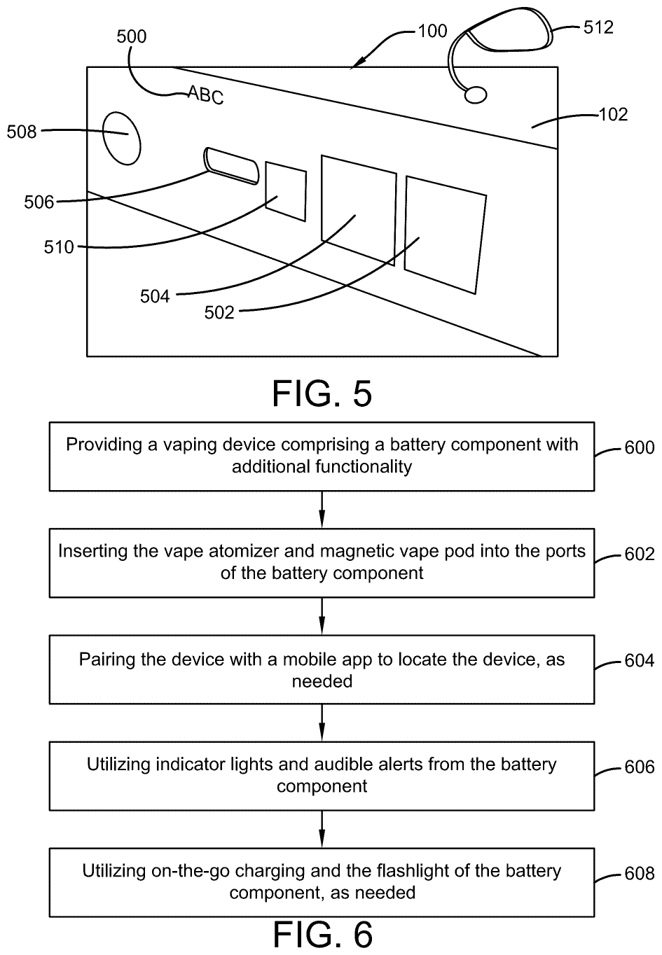

As shown in FIG. 5, the bottom side 110 of the battery component 102 comprises a speaker 502 for an audible chime/alert and a microphone 504 for voice recognition and/or voice commands. Thus, a user can audibly speak voice commands, such as ‘find my vape’ and then be alerted via an audible alert/chime when the vape has been located. The microphone 504 can also comprise voice recognition, preventing others from picking up the battery component 102 and locating the vape.

Further, the bottom side 110 can also comprise a charging port 506 for charging other devices, as needed. These devices can include, vapes, cellular phones, smartwatches, iPads, iPods, etc., or any other suitable device as is known in the art. Further, any suitable type of charging port 506 can be utilized as well.

Additionally, the battery component 102 comprises indicator lights 508 to show that the device 100 is paired to Bluetooth correctly and that the magnetic pods 130 and vape atomizer 124 are correctly in place. The indicator lights 508 can also show if the battery component 102 needs to be recharged and to show if the device 100 is powered on or off. Any suitable number of indicator lights 508 can be utilized as is known in the art.

In one embodiment, the battery component 102 also comprises a flashlight 510. The flashlight 510 is optional but can be included on any suitable position on the battery component 102, depending on the needs and/or wants of a user. Any suitable type of flashlight 510 can be provided with the battery component 102 as is known in the art.

In another embodiment, the battery component 102 comprises a wrist lanyard 512 or other suitable means for releasably securing the device 100 to a user. The wrist lanyard 512 secures around a user's wrist and allows the device 100 to be easily transported, as needed. The wrist lanyard 512 is typically a small cord, rope or twine that loops around a user's wrist and is secured to the device 100 during transport.

In yet another embodiment, the vaping device 100 comprises a plurality of indicia 500. The battery component 102 of the device 100 may include advertising, a trademark, or other letters, designs, or characters, printed, painted, stamped, or integrated into the battery component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be battery, vape, or brand related.

FIG. 6 illustrates a flowchart of the method of locating a vape via integrated GPS technology. The method includes the steps of at 600, providing a vaping device comprising a battery component with additional functionality. The method also comprises at 602, inserting the vape atomizer and magnetic vape pod into the ports of the battery component. Further, the method comprises at 604, pairing the device with a mobile app to locate the device, as needed. The method also comprises at 606, utilizing indicator lights and audible alerts from the battery component. Finally, the method comprises at 608, utilizing on-the-go charging and the flashlight of the battery component, as needed.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “vaping device” and “device” are interchangeable and refer to the vaping device 100 of the present invention.

Notwithstanding the forgoing, the vaping device 100 of the present invention can be of any suitable size and configuration as is known in the art without affecting the overall concept of the invention, provided that it accomplishes the above stated objectives. One of ordinary skill in the art will appreciate that the vaping device 100 as shown in FIGS. 1-6 is for illustrative purposes only, and that many other sizes and shapes of the vaping device 100 are well within the scope of the present disclosure. Although the dimensions of the vaping device 100 are important design parameters for user convenience, the vaping device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vaping device that integrates GPS technology to enable location of a vape, the vaping device comprising:
a battery component;
wherein the battery component includes a wireless communications module and additional sensors which would allow the vaping device to pair with a mobile application on a smart device;
wherein once paired, a user could control and locate the vaping device via the mobile application; and
further wherein the battery component pairs with a smartphone via Bluetooth technology.

2. The vaping device of claim 1, wherein the battery component is a lithium battery.

3. The vaping device of claim 2, wherein the battery component comprises a top surface, a bottom surface, a top side, an opposing bottom side, and opposing sidewalls.

4. The vaping device of claim 3, wherein the battery component provides approximately 48 hours of charge.

5. The vaping device of claim 4, wherein the battery component comprises a controller which includes a software and hardware assembly and Bluetooth technology for sending and receiving signals from other components of the vaping device.

6. The vaping device of claim 5, wherein the battery component comprises a microcontroller unit (MCU) for controlling a vape atomizer and providing data about usage analysis to the software and hardware assembly.

7. The vaping device of claim 6, wherein the mobile app keeps track of date and time of vape use and other usage analysis.

8. The vaping device of claim 7, wherein the top surface of the battery component comprises a first port for screwing on a vape atomizer.

9. The vaping device of claim 8, wherein the top surface of the battery component comprises a second port for inserting a magnetic vape pod.

10. The vaping device of claim 9, wherein a mouthpiece is releasably secured to a front end of the vape atomizer and a body of the vape atomizer contains a liquid, such as tobacco, nicotine, non-nicotine, cannabis, CBD, and essential oils, or any combination thereof.

11. The vaping device of claim 10, wherein the magnetic vape pod is internally flat on a surface and houses a rechargeable battery, wherein the vape atomizer and the magnetic vape pod are attached together during use.

12. The vaping device of claim 11, wherein the bottom surface of the battery component comprises a speaker for an audible alert and a microphone for voice recognition and/or voice commands.

13. A vaping device that integrates GPS technology to enable location of a vape, the vaping device comprising:
a battery component comprising a top surface, a bottom surface, a top side, an opposing bottom side, and opposing sidewalls;
wherein the battery component includes a wireless communications module and additional sensors which would allow the vaping device to pair with a mobile application on a smart device;
wherein once paired, a user could control and locate the vaping device via the mobile application;
wherein the battery component comprises a controller which includes a software and hardware assembly and Bluetooth technology for sending and receiving signals from other components of the vaping device;
wherein the battery component comprises a microcontroller unit (MCU) for controlling a vape atomizer and providing data about usage analysis to the software and hardware assembly;
wherein the mobile app keeps track of date and time of vape use and other usage analysis;
wherein the top surface of the battery component comprises a first port for screwing on a vape atomizer;
wherein the top surface of the battery component comprises a second port for inserting a magnetic vape pod; and
further wherein the bottom surface of the battery component comprises a speaker for an audible alert and a microphone for voice recognition and/or voice commands.

14. The vaping device of claim 13, wherein the bottom surface comprises a charging port for charging other devices.

15. The vaping device of claim 13, wherein the battery component comprises indicator lights to show that the vaping device is paired to Bluetooth correctly and that the magnetic pod and the vape atomizer are correctly in place.

16. The vaping device of claim 13, wherein the battery component comprises a flashlight.

17. The vaping device of claim 13, wherein the battery component comprises a wrist lanyard.

18. The vaping device of claim 13 further comprising a plurality of indicia.

19. The vaping device of claim 13, wherein the vape atomizer contains a liquid, such as tobacco, nicotine, non-nicotine, cannabis, CBD, and essential oils, or any combination thereof.

20. A method of locating a vape via integrated GPS technology, the method comprising the following steps:
providing a vaping device comprising a battery component with additional functionality; inserting the vape atomizer and magnetic vape pod into the ports of the battery component; pairing the device with a mobile app to locate the device, as needed;
utilizing indicator lights and audible alerts from the battery component; and
utilizing on-the-go charging and the flashlight of the battery component, as needed.
